(19) United States
(12) Patent Application Publication
(10) Pub. No.: US 2019/0279541 A1
(43) Pub. Date: Sep. 12, 2019

(54) APPARATUS AND METHODS OF IMPROVEMENT OF ILLUMINATING ADDRESS AND SIGNAGE FOR BUILDINGS AND OTHER STRUCTURES

(71) Applicant: Lukas Garza, Skokie, IL (US)

(72) Inventor: Lukas Garza, Skokie, IL (US)

(21) Appl. No.: 16/298,489

(22) Filed: Mar. 11, 2019

Related U.S. Application Data
(60) Provisional application No. 62/640,928, filed on Mar. 9, 2018.

(51) Int. Cl. G09F 13/22; F21S 8/00; G09F 13/04; F21S 4/28; F21S 10/02; F21S 10/00; F21S 9/03; H04M 11/02

(52) U.S. Cl. CPC G09F 13/22; F21S 8/033; G09F 13/0413; G09F 13/0404; F21S 4/28; G09F 2013/0445; F21S 10/005; F21S 9/037; H04M 11/025; G09F 2013/222; G09F 2013/0422; F21S 10/02

(57) ABSTRACT

An illuminated sign for a commercial or residential building is provided. The illuminated sign comprises a body having a design portion. The body of the sign includes at least one reflective surface and at least one solar panel along at least one edge of the body of the sign. The solar panel electrically coupled to a charge control that is electrically coupled to a battery. The battery being electrically coupled to a LED driver that controls the electrical current provided from the battery to an LED light strip that is used to illuminate the illuminated sign.

### CROSS-REFERENCE TO RELATED APPLICATION

This application claims priority to and claims the benefit of U.S. Provisional Application No. 62/640,928, filed Mar. 9, 2018, which is incorporated herein by reference.

### FIELD OF THE DISCLOSURE

This disclosure relates to an improved apparatus and method for illuminating a sign for a commercial or residential building.

### BACKGROUND OF THE DISCLOSURE

Currently known illuminated signs for commercial or residential buildings draw their electrical power from the electrical hard wiring of the commercial or residential building they are attached or by using large solar panels that may be adjacent to, but due to their size, are separate from, the illuminated sign. Therefore, an illuminated sign is needed that is capable of providing illumination without being hardwired to the electrical supply of a commercial or residential building and that is capable of housing solar panels within the confines of the illuminated sign.

The illuminated sign disclosed herein will not be required to be electrically hardwired to the commercial or residential building it is attached to nor will it require the use of large solar panels that are not built into the illuminated sign. Rather, the illuminated sign disclosed herein will be able to be simply mounted to the commercial or residential building and then the built in solar panels will charge the built in batteries so that the illuminated sign may be illuminated when dark or any other time selected by the user.

### BRIEF SUMMARY OF THE DISCLOSURE

In one aspect according to the present application, an illuminated sign is provided. The illuminated sign comprising a body including a design portion. The illuminated sign further comprising a reflective surface and a solar panel coupled to at least one edge of the body. The solar panel is electrically coupled to a charge control that is electrically coupled to a battery. The battery is electrically coupled to a LED driver that is electrically coupled to a LED light strip and the LED driver controls the amount of electrical current the battery sends to the LED light strip.

In another aspect according to the present application, the body of the illuminated sign is composed of a plexiglass or an aluminum.

In another aspect according to the present application, the reflective surface is a mirror.

In still yet another aspect according to the present application, the illuminated sign has a second reflective surface coupled to a second edge of the body.

In yet another aspect according to the present application, the design portion is one of etched, engraved, or cut into the body.

In another aspect according to the present application, the battery is rechargeable.

In still yet another aspect according to the present application, the LED driver controls the color of the LED light strip.

In yet another aspect according to the present application, the illuminated sign includes a camera that is housed within the body of the illuminated sign.

In still yet another aspect according to the present application, the illuminated sign includes an object sensor housed within the body of the illuminated sign.

In yet another aspect according to the present application, the illuminated sign includes a speaker housed within the body of the illuminated sign.

According to one aspect of the present application, a system for illuminating a sign of a commercial or residential building is provided. The system includes a sign having a body including a design portion. The sign including a reflective surface and a solar panel coupled to at least one edge of the body where the solar panel is electrically coupled to a charge control that is electrically coupled to a battery. The battery is electrically coupled to a LED driver that is electrically coupled to a LED light strip and the LED driver controls the amount of electrical current the battery sends to the LED light strip.

In another aspect according to the present application, the design portion is a numeral, a letter, a picture, or a drawing.

In yet another aspect according to the present application, the sign further comprises a receiver and a transmitter.

In still yet another aspect according to the present application, the sign is connected to a network and can transmit and receive data over the network via the receiver and transmitter.

In another aspect according to the present application, the network is a WIFI network or a Bluetooth network.

In still yet another aspect according to the present application, the system further comprises a remote control that is communicably couplable to the sign over the network.

In yet another aspect according to the present application, the remote control can transmit data to the sign, such that the brightness and color of the LED light strip can be controlled using the remote control.

In still yet another aspect according to the present application, the remote control can transmit data to the sign to start a timer of the sign that controls the duration of time that LED driver provides electrical current from the battery to the LED light strip.

In yet another aspect according to the present application, the sign includes a camera located in the body of the sign and the camera is electrically coupled to a memory card, such that the camera can record an image or a video.

In still yet another aspect according to the present application, an object sensor is located in the body of the sign and the object sensor is capable of detecting the presence of an object and transmitting data over the network to alert a user of the presence of the object.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present disclosure and, together with the description, serve to explain the principles of the disclosure. In the drawings:

FIG. 1 depicts one embodiment of an illuminated sign according to one aspect of the present disclosure; and

FIG. 2 depicts another embodiment of an illuminated sign according to another aspect of the present disclosure.

While the disclosure will be described in connection with certain preferred embodiments, there is no intent to limit it to those embodiments. On the contrary, the intent is to cover all alternatives, modifications and equivalents as included within the spirit and scope of the disclosure as defined by the appended claims.

### DETAILED DESCRIPTION OF THE INVENTION

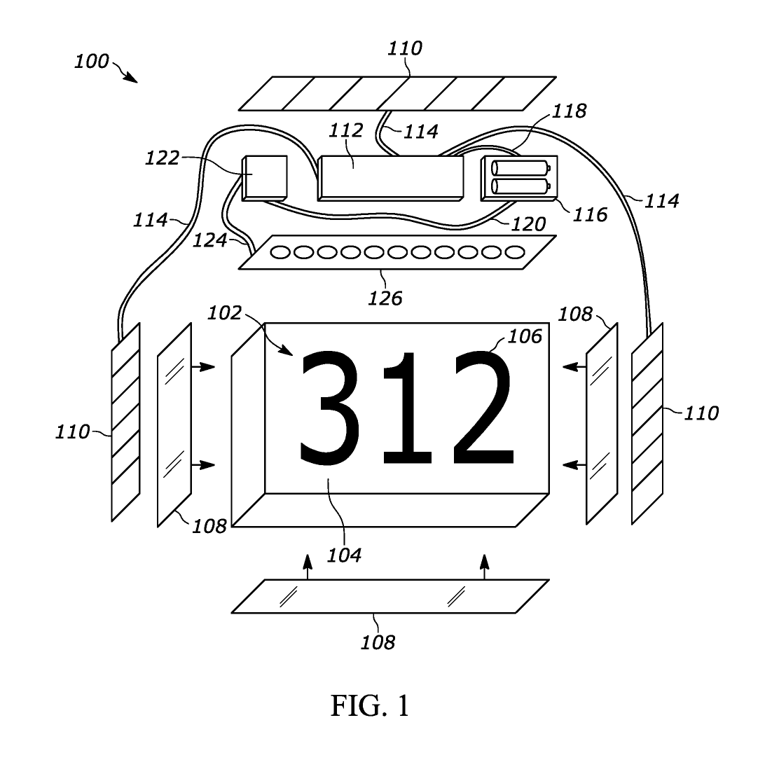

FIG. 1 illustrates one embodiment of an illuminated sign 100 for use in a commercial or residential building according to one aspect of the present application. The illuminated signage 100 includes a sign 102. The sign 102 has a body 104 with a display portion 106.

According to one aspect of the present application, the body 104 of the sign 102 is made from a plexiglass material and the design portion 106 is made by etching or engraving the numbers “312” into the plexiglass material of the body 104.

As will be understood, the sign 102 can be made from any material generally known in the art, such as, but not limited to, any metal material including, but not limited to aluminum, any plastic material including, but not limited to plexiglass, or any stone material.

As will also be understood, it is envisioned that in alternative embodiments the body 104 of the illuminated signs 100 governed by the principles of the present application can be any size or shape required by the user, such as, but not limited to, a square shape, a rectangular shape, a circular shape or a triangular shape.

According to one exemplary embodiment of the present application, the display portion 106 can be formed into the body 104 of the sign 102 by etching or engraving the display portion into the body 104 of the sign 100

According to another exemplary embodiment of the present application, the display portion 106 can be formed into the body 104 of the sign 102 by cutting out the display portion 106 from the body 104 of the sign 102.

As will also be understood, the display portion 106 can take the form of any object or illustration desired by the user, such as, but not limited to, any type or style of number, any type or style of letter, word, or sentence, any type of picture, any type or kind of drawing, or any type or kind of graphical design.

As will also be appreciated, the body 104 of the illuminated sign 100 can also include any coupling means generally known in the art, such as, but not limited to a mechanical coupling means including, but not limited to, a bracket or screw, an adhesive coupling means including, but not limited to a glue or an epoxy, or a magnetic coupling means, such that the user can couple the illuminated sign 100 to any surface of the users choosing.

Turning back to FIG. 1, the illuminated sign 100 further comprises reflective surfaces 108 that surround one or more of the edges of the body 104 of the sign 102. The reflective surfaces 108 can be any material that reflects light that is generally known in the art, such as but not limited to, any type of glass reflective material including, but not limited to a mirror, any type of reflective metal material, or any type of reflective plastic material.

As will be appreciated, the reflective surfaces 108 of the sign 102 provide a more even illumination of the display portion 106 of the sign 102 as it is illuminated while at the same time minimizing any light leakage from the illuminated sign 100.

In one exemplary embodiment according to the present application, the number of reflective surfaces 108 will be sufficient enough such that the sign 102 has virtually no light leakage.

As will also be appreciated, by minimizing or completely preventing light leakage it allows the sign 102 to be sufficiently illuminated by less or less powerful lighting, which in turn requires less electrical energy to properly illuminate the illuminated sign 100, which in turn allows for smaller solar panels 110 and/or increased electrical capabilities in the illuminated sign 100, as will be discussed herein.

As also illustrated in FIG. 1, the sign 102 also has solar panels 110 that surround at least one edge of the body 104 of the sign 102. In the embodiment illustrated in FIG. 1, the sign 102 has three solar panels 110 that are electrically coupled to a charge controller 112 by a first, second, and third electrical wire 114.

The sign 102 further comprises a rechargeable battery 116 that is electrically coupled to the charge controller 112 by a fourth electrical wire 118. The rechargeable battery 116 is electrically connected by a fifth electrical wire 120 to a LED driver 122. The LED driver regulates and directs when the electrical charge stored in the rechargeable battery 116 is to be sent to the LED light strip 126 that is electrically coupled to the LED driver 122 via a sixth electrical wire 124.

As will be understood, the LED driver 122 can be programmed to control any feature of the LED light strip 126 generally known in the art, such as, but not limited to, the brightness of the light given off by the LED light strip 126, the warmth of the light given off by the LED light strip 126, or the color of the light given off by the LED light strip 126.

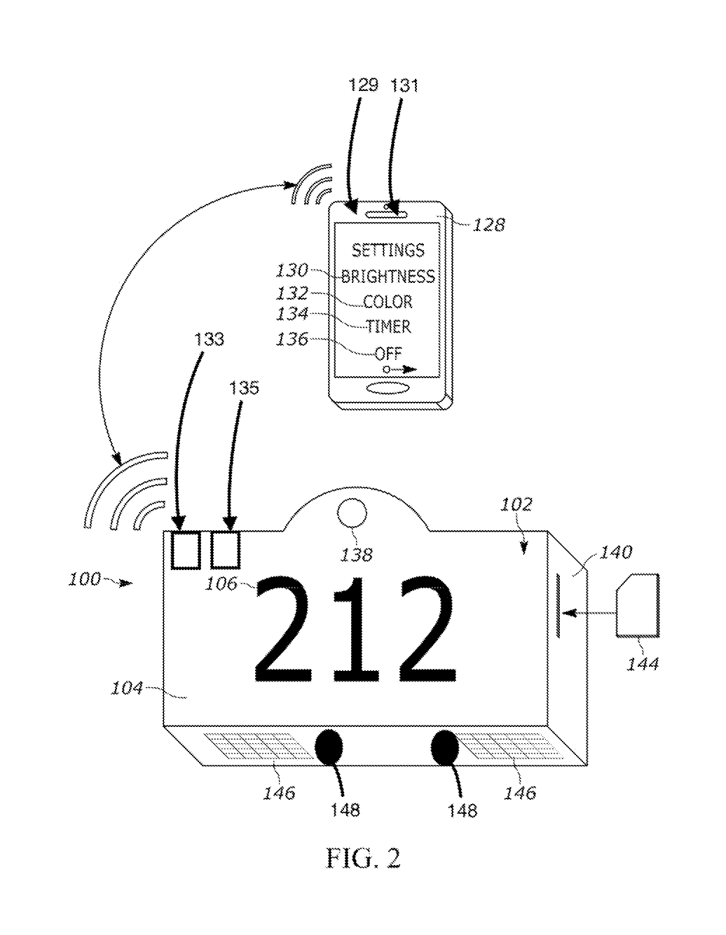

Turning to FIG. 2, illustrating another exemplary embodiment of an illuminated sign 200 for a commercial or residential building according to one aspect of the present application. As will be understood, illuminated sign 200 illustrated in FIG. 2 includes all of the same features of the illuminated sign 100 illustrated in FIG. 1. However, the embodiment of the illuminated sign 200 illustrated in FIG. 2 includes a number of “smart features” that are not illustrated in the illuminated sign 100 illustrated in FIG. 1.

As illustrated in FIG. 2, the illuminated sign 200 includes a remote controller 128 that can send and receive data from the illuminated sign 200. The remote controller 128 includes at least one receiver 129 and at least one transceiver 131 and the illuminated sign 200 also includes at least one receiver 133 and at least one transceiver 135. It will be understood, that the remote controller 128 receiver 129 and transceiver 129 and the illuminated sign 200 receiver 133 and transceiver 135 can be any type of receiver or transceiver that is generally known in the art.

In one exemplary embodiment according to one aspect of the present application, the receiver 129 and transceiver 131 of the remote controller 128 and the receiver 133 and transceiver 135 of the illuminated sign 200 will be communicably connected to each other over a Bluetooth Network.

In another exemplary embodiment according to one aspect of the present application, the receiver 129 and transceiver 131 of the remote controller 128 and the receiver 133 and transceiver 135 of the illuminated sign 200 will be communicably connected to each other over a wireless communication network.

In still yet another exemplary embodiment according to one aspect of the present application, the receiver 129 and transceiver 131 of the remote controller 128 and the receiver 133 and transceiver 135 of the illuminated sign 200 will be communicably connected to each other over a cellular network.

Turning back to FIG. 2, the remote controller 128 can control features of the illuminated sign 200, such as, but not limited to, the brightness 130 of the sign 102 and the color 132 of the sign 102. The remote control 128 can also be used to set a schedule or timer controlling when the sign 102 will be illuminated or cease being illuminated. The remote control 128 also has the ability to turn the illumination of the sign 102 on and off using the on/off button 136 provided on the remote controller 128.

As illustrated, the illuminated sign 200 also includes a camera 138 that is secured to the body 104 of the sign 102. The body 104 of the illuminated sign 200 illustrated in FIG. 2 also includes a slot 140 to insert a memory card 144.

As will be understood, a user can insert a memory card 144 including, but not limited to, a Micro-SD card, which can be electrically coupled to the camera 138 of the illuminated sign 200, such that the camera 138 can store any images or video taken by the camera 138 on the memory card 144 for later viewing by the user.

In other embodiments governed by the principles of the present application, it is envisioned that the image and/or video data captured by the camera 138 can be transmitted by the transceiver 135 of the illuminated sign 200 over a network that the illuminated sign 200 is connected to where the image and/or video data captured can be saved so that the user can either remotely stream the image and/or video data being captured live by the camera 138 or the user can remotely view previously saved image and/or video data captured by the camera 138.

The illuminated sign 200 also includes speakers 146 that are built directly into the body 103 of the illuminated sign 200.

According to one exemplary embodiment of the present application, it is envisioned that the speakers 146 include a microphone that allows for a user to communicate with another person who is located near the illuminated sign 200.

According to another exemplary embodiment of the present application, it is envisioned that the speakers 146 can also be pre-programmed to sound an alarm noise when remotely triggered to do so by a user, such as to scare away an intruder or any other type of suspicion person located near the illuminated sign 200.

The illuminated sign 200 also includes object detectors 148 that are also housed within the body 104 of the illuminated sign 200. The object detectors 148 can be any type of object detectors 148 generally known in the art, such as, but not limited to, proximity sensors including, but not limited to, ultrasonic sensors, capacitive sensors, photoelectric sensors, inductive sensors, or magnetic sensors; motion detectors including, but not limited to, infrared light sensors, ultrasound sensors, or microwave/radar sensors; and image sensors including, but not limited to, cameras, camera modules and other imaging devices based on CCD or CMOS technology.

The object detectors 148 can be programmed to detect the presence of any new objector within the range of the object detector 148. As will be appreciated, it is envisioned that many embodiments of the illuminated signs 100, 200 disclosed herein will be located at or nearby the entranceway of commercial or residential buildings where most package deliveries are made. Therefore, according to one aspect of the present application, the object detector 148 of the illuminates sign 200 can be programmed to detect the presence of a new object, such as a delivered package. The illuminated sign 200 can then transmit a signal to the user informing the user of the presence of the new package.

For example, the illuminated sign can be configured to send to the user an email, text message, phone notification, or even a phone call over a WIFI or Bluetooth network that the illuminated sign 200 is operably coupled with in order to inform the user of the presence of the new package so that the user can either come to immediately pick up the package for safe keeping or even so that the user can then remotely monitor the package via the camera 138 of the illuminated sign 200 or even set up additional alerts to be notified if another object, such as a person, is detected near the delivered package.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An illuminated sign comprising:
a body including a design portion;
a reflective surface and a solar panel coupled to at least one edge of the body;
wherein the solar panel is electrically coupled to a charge control that is electrically coupled to a battery;
wherein the battery is electrically coupled to a LED driver that is electrically coupled to a LED light strip; and
wherein the LED driver controls the amount of electrical current the battery sends to the LED light strip.

2. The illuminated sign of claim 1, wherein body is composed of a plexiglass or an aluminum.

3. The illuminated sign of claim 1, wherein the reflective surface is a mirror.

4. The illuminated sign of claim 1, wherein a second reflective surface is coupled to a second edge of the body.

5. The illuminated sign of claim 1, wherein the design portion is one of etched, engraved, or cut into the body.

6. The illuminated sign of claim 1, wherein the battery is rechargeable.

7. The illuminated sign of claim 1, wherein the LED driver controls the color of the LED light strip.

8. The illuminated sign of claim 1, wherein a camera is housed within the body.

9. The illuminated sign of claim 1, wherein an object sensor is housed within the body.

10. The illuminated sign of claim 1, wherein a speaker is housed within the body.

11. A system for illuminating a sign of a commercial or residential building comprising:
a sign having a body including a design portion;
a reflective surface and a solar panel coupled to at least one edge of the body;
wherein the solar panel is electrically coupled to a charge control that is electrically coupled to a battery;
wherein the battery is electrically coupled to a LED driver that is electrically coupled to a LED light strip; and
wherein the LED driver controls the amount of electrical current the battery sends to the LED light strip.

12. The system of claim 11, wherein the design portion is a numeral, a letter, a picture, or a drawing.

13. The system of claim 11, wherein the sign further comprises a receiver and a transmitter.

14. The system of claim 13, wherein the sign can connect to a network and transmit and receive data over the network via the receiver and transmitter.

15. The system of claim 14, wherein the network is a WIFI network or a Bluetooth network.

16. The system of claim 14, wherein the system further comprises a remote control that is communicably couplable to the sign over the network.

17. The system of claim 16, wherein the remote control can transmit data to the sign, such that the brightness and color of the LED light strip can be controlled using the remote control.

18. The system of claim 11, wherein the remote control can transmit data to the sign to start a timer of the sign that controls the duration of time that LED driver provides electrical current from the battery to the LED light strip.

19. The system of claim 11, wherein a camera is located in the body and the camera is electrically coupled to a memory card, such that the camera can record an image or a video.

20. The system of claim 14, wherein an object sensor is located in the body and the object sensor is capable of detecting the presence of an object and transmitting data over the network to alert a user of the presence of the object.
